(19) United States
(12) Patent Application Publication
(10) Pub. No.: US 2026/0247501 A1
(43) Pub. Date: Aug. 20, 2026

(54) A HEATING WINDOW ON AN AUTOMOTIVE GLAZING

(71) Applicants: Naveinah CHANDRASEKARAN, Chennai, Tamil Nadu (IN); SAINT-GOBAIN SEKURIT FRANCE, THOUROTTE (FR)

(72) Inventors: Naveinah CHANDRASEKARAN, Chennai, Tamil Nadu (IN); Bernard NGHIEM, SAINT-VAAST-DE-LONGMONT (FR)

(21) Appl. No.: 19/119,624

(22) PCT Filed: Sep. 25, 2023
(86) PCT No.: PCT/IN2023/050884

§ 371 Date: Apr. 9, 2025

(30) Foreign Application Priority Data
Oct. 10, 2022 (IN) 202241057758

(51) Int. Cl. H05B 3/86

(52) U.S. Cl. CPC H05B 3/86; H05B 2203/013; H05B 2214/04

(57) ABSTRACT

A heating window on an automotive glazing includes one or more heatable patches composed of functionally graded material containing metal nano constituents dispersed in a solvent and a power supply unit configured to power the one or more heatable patches. The automotive glazing includes a laminated unit of at least two panes of glass or polymer sandwiched with an interlayer therebetween and the one or more heatable patches are having optimal optical and thermal performance to provide improved uniform heating on a specific region of the glazing over which the heating window is disposed.

### FIELD OF TECHNOLOGY

The present invention relates to a heating system in an automotive glazing. Particularly, the present invention relates to a heating system in the automotive glazing having functionally made defogger units for specific automotive applications.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

It is known to one skilled in the art that glazing refers to any and all the glass or polymer or similar material within a structure or it is the installation of any piece of glass or polymer or such similar material within a sash or frame. The glass windows of an automobile are referred to as glazing. For laminated glazing, two or more layers of glass or a similar material, are fused together with an interlayer in the middle. The fusion is completed with pressure and heat, and it prevents the sheets of glass or polymer or the similar material from breaking.

Heating automotive glazing like windshield in foggy and cold climate conditions is a key requirement for the driver's safety as it impacts the visibility of the windshield. Known in the art are various ways to heat the windshield and conventional solutions include defoggers or heating grid widely used to heat the tempered glazing units. However, such solutions would be easily applicable to backlite of the vehicle and might not be suitable for windshield which is the front window of a vehicle, and it uses laminated glazing.

Known in the art are heating solutions of having specific conductive lines of metal (like silver) being provided in specific regions in windshield. Such conductive lines are either made of expensive transparent ink or are made extremely thin so as to not affect the driver's vision zone in the windshield.

Advanced driver assistance system (ADAS) in different vehicles include multiple types of cameras in a single imaging system. Such camera systems may include one or more lens with different focal points, or the lens may be having different wide-angle measures. Some lens may have a smaller focal length and hence any non-transparent heating lines or defoggers through it will make the lines look magnified in the image and will disrupt the view of the actual object, thereby disturb the ADAS functionality itself. For defogging the camera region of the glazing (say windshield), defoggers lines are strategically provided over the camera region such as the ones placed in FIGS. 1a and 1b. Most of the designs of such defogger lines takes about 30 mins for de-icing. This timer duration is regarded as high since it will affect the safety needs in ADAS systems. If such ADAS based solutions are part of autonomous vehicle, then in that case, it is required to have faster defogging or de-icing. If this does not happen, it may lead to issues, especially in autonomous vehicles. Reference is made to FIGS. 1a and 1b that depict some heating solutions for an imaging system having three lenses. If the non-transparent heating lines were to be replaced with transparent lines, such as the design shown in FIG. 1a or FIG. 1b, the de-icing time further increases. In these designs, there still may be some portions of ice left to be defogged as shown in the thermal map in FIG. 1b.

A reference is made to KR20210120225A that discloses a transparent heating film located on a transparent substrate, comprising a plurality of metal nanostructures forming a plurality of intersection points by contacting each other. The transparent heating film further includes an adhesive layer in contact with the metal nanostructures and is located on the transparent substrate. At least one of the metal nanostructures forms a first intersection point with the other one of the metal nanostructures, and at least one of the metal nanostructures includes a protrusion protruding outside the adhesive layer and an impregnated portion impregnated inside the adhesive layer, in which a portion of the first intersection is included in the protrusion. However, such films may not be suitable for laminated glazing units. For laminated units, the material should be able to withstand the lamination process parameters such as but not limited of the bending cycles. The referred solution also speaks of having a specific adhesive layer with protrusion features, which is an additional parameter to be regarded.

Another reference is made to CN205546005U that discloses a car rear windshield defogging defroster in which the heating plate of the defroster is for handing over interdigital electrode or broach form electrode structure, including thick strip electrode, slice electrode and transparent conducting film, transparent conducting film contacts respectively with thick strip electrode, slice electrode to fill up the region that whole thick strip electrode and slice electrode enclose. The heating plate is interdigital electrode, or the design of the heating plate is comb-like electrode structure, including thick strip electrode, slice electrode and transparent conducting layer. The transparent conducting layer contacts with thick strip electrode, slice electrode, and fills up whole thick strip electrode and region that slice electrode surrounds. Such solutions would be inappropriate for being applied in windshield as it will affect driver's vision zone.

Yet another reference is made to CN104053256B that discloses a heating solution based on nano-silver wire transparent conductive film. As per this solution, the nano silver wire synthesized with low temperature liquid polymerization process is used for raw material and with filming technology is coated transparent conductive films. This solution is primarily focused on the method of manufacturing such a film. However, these steps do not take into consideration the requirements of laminated glazing.

In regard of the prior art known and the drawbacks thereof, it is observed that there is a dire requirement of a heating solution for automotive glazing which does not affect the driver's vision zone, capable of withstanding the process parameters of lamination, the optical and thermal requirements of the automotive glazing and is cost-effective. Additionally, it is desirous to have the heating solution to defog or de-ice a zone on the glazing near the camera region within an optimal time.

### SUMMARY OF THE INVENTION

An object of the present invention is to provide a heating solution to overcome the drawbacks of the prior art.

Another object of the present invention is to provide a heating solution in the automotive glazing having a printed circuit or system to heat to defog the glazing.

Another object of the present invention is to provide a heating solution with electronic circuit system that is transparent or made gradually transparent or partially transparent.

Yet another object of the present invention is to provide a heating window for the automotive glazing like windshield for defogging without affecting vision zone of a driver.

Still another object of the present invention is to provide a heating window for the automotive glazing like windshield for defogging a camera region in an optimal time.

A further object of the present invention is to provide a heating window for the automotive glazing with laminated unit, in which, the heating window complies with the process parameters of lamination.

These and other objects of the invention are achieved by the following aspects of the invention. The following disclosure presents a simplified summary of the invention in order to provide a basic understanding of some aspects of the invention. This presents some concept of the invention in a simplified form to a more detailed description of the invention presented later. It is a comprehensive summary of the disclosure and it is not an extensive overview of the present invention. The intend of this summary is to provide a fundamental understanding of some of the aspects of the present invention.

In an aspect of the present invention is disclosed a heating window on an automotive glazing. Said heating window comprises one or more heatable patches composed of functionally graded material containing metal nano constituents dispersed in a solvent, and a power supply unit configured to power said one or more heatable patches. The automotive glazing comprises a laminated unit having at least two panes of glass or polymer sandwiched with an interlayer therebetween and the one or more heatable patches are having optimal optical and thermal performance to provide improved uniform heating on a specific region of the glazing over which said heating window is disposed. Functionally graded materials are referred to as material that exhibits a control over composition and thickness and thereby having an impact on the transparency and sheet resistance.

In this aspect of the present invention, said specific region of the glazing is over an arrangement of an imaging system. The patch is configured to exhibit required thermal gradient and transparency gradient. The material composition of the patch is selected based on one or more of the parameters: manufacturing parameters, transparency, the thermal gradient and other thermal parameters of the window and the glazing. The composition of the functionally graded material is adapted to provide location specific optical and thermal functionalities, wherein said material exhibits same or different functionalities at different location of the window. The material composition of the patch is such that said window is optimized for required optical vision requirements of the imaging system. The solvent is an adhesive solvent whereby the patch comprises multiple silver nanowires and silver nanoparticles dispersed in it. The silver nanowires are dispersed sparsely to obtain a substantial transparency of 80-95%. The heating window comprises of transparent and non-transparent particles. The non-transparent particle may be used to increase the heat distribution and non-transparent metal constituents can be primarily used as bus bars or power supply. The patch includes a scratch resistant, a temperature resistant, and a corrosion resistant encapsulant. This encapsulant is a metal oxide with transparency corresponding to the transparency of the patch. The automotive glazing referred herein may be a windshield, sidelite, backlite, sunroof or quaterlite.

In another aspect of the present invention is disclosed a heating system comprising one or more heating windows one or more heatable patches composed of functionally graded material containing metal nano constituents dispersed in a solvent. The heating system is configured to heat a region over an imaging system from a first temperature to a second temperature in an optimal time. The patch of the heating window is configured to defog the region at the same time complying with the desired transparency, haze or distortion level, the optimal heating rate, the threshold temperature, the time to heat and the temperature gradient of the window and the glazing.

The significant features of the present invention and the advantages of the same will be apparent to a person skilled in the art from the detailed description that follows in conjunction with the annexed drawings.

### BRIEF DESCRIPTION OF THE ACCOMPANYING DRAWINGS

The following briefly describes the accompanying drawings, illustrating the technical solution of the embodiments of the present invention or the prior art, for assisting the understanding of a person skilled in the art to comprehend the invention. It would be apparent that the accompanying drawings in the following description merely show some embodiments of the present invention, and persons skilled in the art can derive other drawings from the accompanying drawings without deviating from the scope of the disclosure.

FIGS. 1a-1b illustrate the heating grid designs over camera region along with the defogging thermal map of those designs as known in the prior art.

FIG. 2 illustrates an exemplary embodiment of the heating window on an automotive glazing according to an embodiment of the present invention.

FIG. 3 illustrates the comparative study of the behaviour of different material considering the parameters of transparency for choosing material for the heatable patch of the present invention.

FIGS. 4a-4c illustrate different embodiments of the heating patches and the arrangement on an automotive glazing according to an embodiment of the present invention.

FIGS. 5a-5b illustrate some experiment results according to an embodiment of the present invention.

Persons skilled in the art will appreciate that elements in the figures are illustrated for simplicity and clarity and have not necessarily been drawn to scale. For example, the dimensions of some of the elements in the figures may be exaggerated relative to other elements to help to improve understanding of embodiments of the disclosure.

### DETAILED DESCRIPTION OF THE INVENTION

The present disclosure is now discussed in more detail referring to the drawings that accompany the present application. It would be appreciated by a skilled person that this description to assist the understanding of the invention but these are to be regarded as merely exemplary.

Features that are described and/or illustrated with respect to one embodiment may be used in the same way or in a similar way in one or more other embodiments and/or in combination with or instead of the features of the other embodiments.

The terms and words used in the following description are not limited to the bibliographical meanings and the same are used to enable a clear and consistent understanding of the invention. Accordingly, the terms/phrases are to be read in the context of the disclosure and not in isolation. Additionally, descriptions of well-known functions and constructions are omitted for clarity and conciseness.

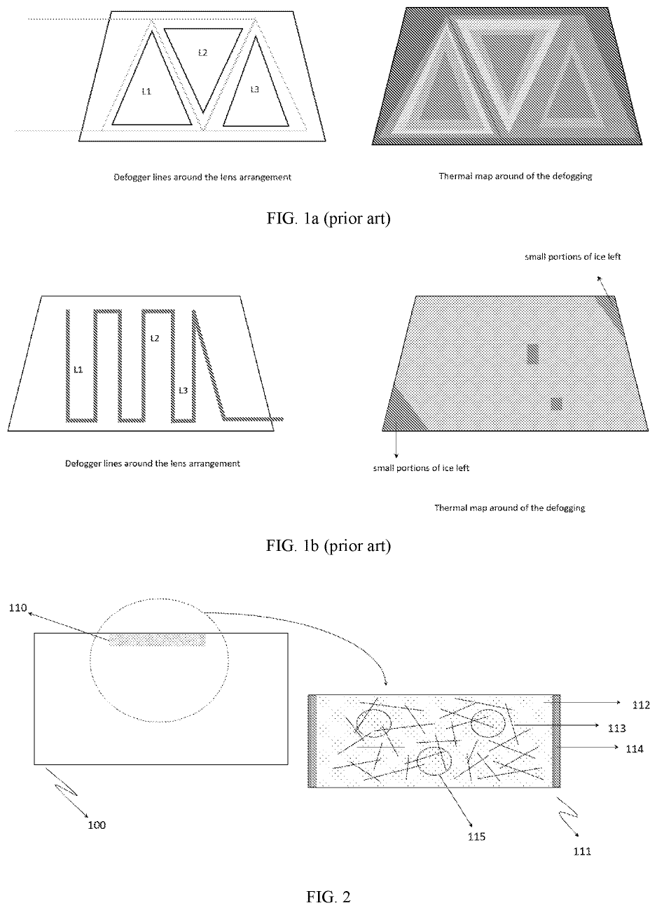

In an embodiment of the present invention is disclosed a heating window (110) on an automotive glazing (100). An exemplary embodiment of this is depicted in FIG. 2. The heatable window or heating window (110) of the automotive glazing comprises one or more heatable patches (111). Said heatable patch is composed of a functionally graded material containing metal nano constituents (113) dispersed in a solvent (112). The automotive glazing (100) comprises a laminated unit of at least two panes of glass or polymer sandwiched with one or more interlayers therebetween. The heatable patches (111) are having optimal optical and thermal performance to provide improved heating specification for example uniform heat distribution or required thermal gradient for on a specific region of the glazing over which said heating window is disposed. The material of the patch is defined as functionally graded in terms of the control it exhibits over composition and thickness. These properties in turn impacts the transparency and device resistance of the patch of heating window. The heatable window further has a power supply unit (114) configured to power said one or more heatable patches. The automotive glazing (100) comprises a laminated unit of at least two panes of glass or polymer sandwiched with an interlayer therebetween and the one or more heatable patches (111) are having optimal optical and thermal performance to provide improved uniform heating specification such as uniform heat distribution or required thermal gradient on a specific region of the glazing over which said heating window is disposed.

In an implementation of the present invention, the conductive lines made of silver nano particle ink are configured to function as busbar or power supply line which may be connected with the transparent patch coated or printed over a specific location of the automotive glazing as functionally graded heating window or heating system. The patch (111) may further include a scratch resistant, a temperature resistant, and a corrosion resistant encapsulant. This encapsulant can be and not limited to a metal oxide or polydimethylsiloxane with transparency corresponding to the transparency of the patch. It is desirous that the encapsulant is capable of withstanding and protecting the patch from the heating impacts of the circuit.

The automotive glazing (100) in which the heating window (110) is arranged may be a windshield, sidelite, backlite, sunroof or quaterlite. A heating system including the heating window (110) disposed in the glazing is configured to heat a region over an imaging system from a first temperature to a second temperature in an optimal time. The patch of the heating window is configured to defog the region at the same time complying with the desired transparency, haze or distortion level, the optimal heating rate, the threshold temperature, the time to heat and the temperature gradient of the window and the glazing.

The patch (111) depicted in FIG. 2 is configured to exhibit required thermal gradient and transparency gradient. The material composition of the patch is selected based on one or more of the parameters: manufacturing parameters, transparency, the thermal gradient and other thermal parameters of the window and the glazing. The composition of the functionally graded material is adapted to provide location specific optical and thermal functionalities, wherein said material exhibits same or different functionalities at different location of the window. The material composition of the patch is such that said window is optimized for required optical vision requirements of the imaging system or camera region (115) or such sensor module region. The patch is preferred to be in an adhesive solvent whereby the patch comprises multiple silver nanowires and silver nanoparticles dispersed in it. The patch is preferred to be in a solvent that provides improved adhesive and stability parameters to the material of the substrate.

In an implementation of the present invention the silver nanowires are disposed sparsely in the solvent. The dispersion of the nanowires may be obtained by means of ink synthesis, ink treatment like sonication before printing to avoid the ink to agglomerate and settle or form clog in the printer. The solvent may be isopropyl alcohol, ethanol or di-isopropyl ether capable of providing uniform heating. In prior art designs, the defoggers are designed to be plotted as copper wire. Such prior art designs provide non-uniform heating, has high joule heating around the wire and undesirable high thermal gradient.

In this implementation of the present invention, by fine-tuning the solvent percentage and its type, the metal nanowire diameter and length, it may be possible to achieve the required level of dispersion of the ink in the substrate. The printed substrate may be annealed after printing so that the solvent may evaporate and only the nanowires will remain in the substrate. In the patch more dispersed wires will ensure uniform heating at the same time. This advantageously shall bring desired transparency requirement as well. By modifying the voltage applied and the thickness or diameter of the nanowires, it would be possible to this achieve at different heating rates and thermal gradient. With the optimization of at least these parameters, the desired defogging within optimal time would be achieved. The thermal properties of the patch should take into account the desired heating rate. A heating rate of say above 5 degrees/min may result in glass cracking. The composition of the patch is so selected that it ensures the thermal gradient requirement, the heating rate and the maximum temperature the device may reach considering the properties of the automotive glazing and the regulatory or safety requirements.

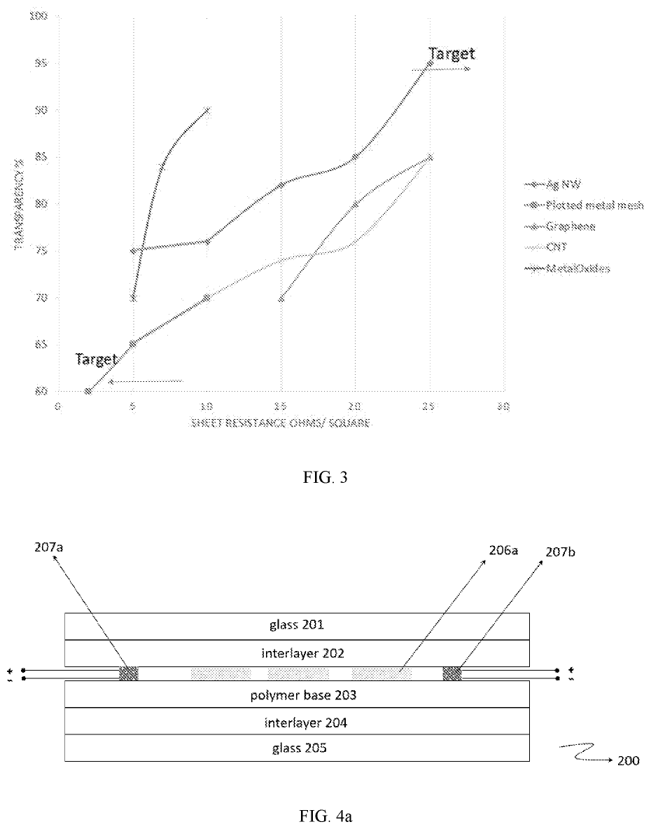

In an implementation, the silver nanowires are dispersed sparsely to obtain a substantial transparency of 80-95%. The material composition of the heatable patch must exhibit a desired transparency of up to 95% and a sheet resistance close to a threshold value (referred to as ‘target’). Additionally, it should withstand manufacturing process parameters such as bending cycles involved in the process of lamination of the automotive glazing. Reference is made to FIG. 3 that shows a comparative study of the behaviour of different material when considering the parameters of transparency. One target depicted in the figure indicates the desired transparency (the target indicated in the upper part of the graph), and another target depicted in the figure is for desired sheet resistance (the target indicated in the lower part of the graph). As would be evidenced from the graph, silver nanowire has desired values. The transmittance values for silver nanowire are much higher than transmittance values of CNTs (carbon nanotubes). Silver nanowires are close to the target for sheet resistance parameter as well. It provides an optical transparency of up to 90% and bending resistance of up to an approximation of 10,000 cycles. The Ag nanowire (NW) after curing (or annealing) will further withstand the lamination, and other manufacturing or operation conditions (for instance and not limited to voltage increase or decrease). In an implementation, the transparent defogger may be composed of network patch of metal nano wires that has suitable mechanical properties, high transparency, low sheet resistance and is compatible with the existing conventional structure of glazing of the vehicle and the manufacture associated parameters.

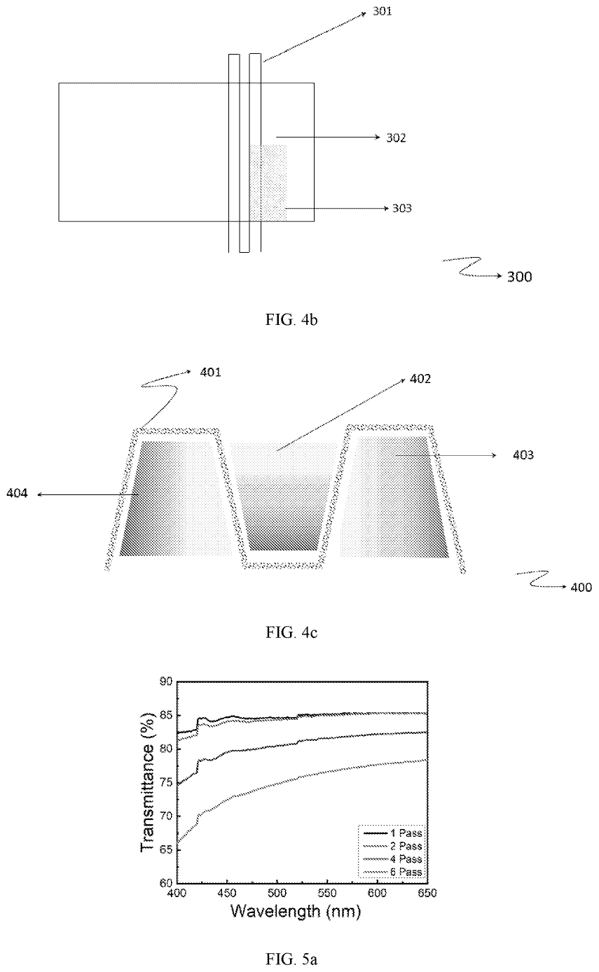

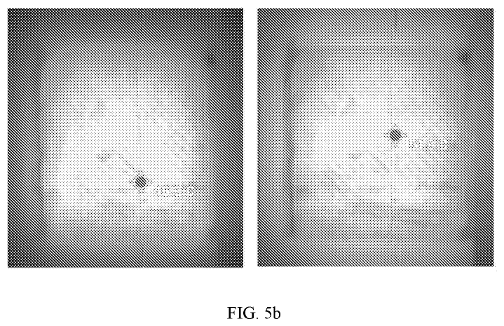

In an embodiment of the invention, the heating window comprises of transparent (206a, 206b, 206c) and non-transparent particles (207a, 207b). The lateral view of this implementation is shown in FIG. 4a. The glazing disclosed in FIG. 4a comprises at least two panes (201, 205) of glass or other similar material. Each of said panes has face 1 and face 2. The glazing unit (200) comprises one or more interlayers (202, 204) of polymer such as polyvinyl butyral (PVB). The patches forming the heating window may be directly disposed on the interlayer or any suitable layer of the glazing. Alternatively, it may be provided on a base polymer (203) such as polyethylene terephthalate (PET) and the thus obtained heatable patch is provided between the glass substrates (201, 205). The heatable patch on PET base (203) may further be laminated using the interlayer. The heating window may be selectively made transparent or non-transparent. For instance, the bus bar or the power connection may include one or more non-transparent conductive heating line (207a, 207b). The heatable patches may be transparent conductive patch. The non-transparent line may be printed over the glass substrate, interlayer or the PET layer. Similarly, the transparent patch may be printed over glass or the interlayer or the PET layer. The transparent patch can also be coated over glass or the interlayer or the PET layer. The non-transparent particles are used to increase the heat distribution and hence, the metal constituents may primarily be used as bus bars.

In an embodiment of the present invention is provided the heating window as disclosed herein may be used for defogging or de-icing a specific region of the glazing (100) such as the region over an arrangement of an imaging system. Said imaging system may include camera lenses arrangement, in which the lens may require transparent medium over glazing for capturing images of objects. Reference is made to FIG. 4b that discloses the heating window (300) disposed over camera region (302) of a glazing. It includes non-transparent heating lines made of silver nano particles (301) of varying thickness. Said conductive lines of silver nano particles comprises transparent heating line with silver nanowire (303) of varying line width. In an implementation, the variation in thickness may be achieved by means of changing the ink extrusion properties of the inkjet printing module for printing the heatable patch. Alternatively, the variation in thickness may be achieved by changing the coating parameters like inlet temperature, lead temperature, coating rate, coating distance from the bed and the like. The transparent patch may be disposed on a glazing over the sensitive camera region. The sheet resistance of the nano particle ink may range from 0.1 mili ohm to 10,000 mili ohm per square. The wire length can range from 1 um to 50 um. The length would be dependent on the printing characteristics. So, essentially there may be control over the thickness and thereby the transparency of the line.

Reference is made to FIG. 4c that discloses a heating system for a glazing such as a windshield. The heating system comprises the heating window (400) having at least three heatable patches (402, 403, 404). In an implementation of the present invention, the heating window (400) is proposed to be laminated within the windshield where the camera system is to be disposed. The camera system comprises of at least 3 cameras or lens units say like a camera 1 (or say lens L1), a camera 2 (or say lens L2) and camera 3 (or say lens L3). The heatable patches are powered by way of a common busway having high sheet resistance, low optical transparency and the material is thus chosen to have faster heating. In this implementation is provided patch (402) having sheet resistance and optical transparency varying from bottom up. This may be suitable for ultra-wide-angle lens. Patch (403) is having varying sheet resistance and optical transparency from right to left and is suitable for being arranged over camera regions having lesser focal length. In the following table is provided is the parameters associated with heating window of this implementation. The overall device resistance provided in the table is measured in ampere since the voltage applied is regarded as fixed.

TABLE 1

| | | Sheet | De- | | | | Overall |
|---|---|---|---|---|---|---|---|
| | | resistance | icing | | | Temperature | Device |
| | Optical | (ohms per | time | Inter-line | Line Width | Gradient | Resistance |
| Type | Transparency | square) | (mins) | Gap | (μm) | (degrees) | (Amps) |
| 401 | From 5% | 0.01-0.2 | <6 | | 180 | <10 | 2-5 |
| | | | | | (high) | | |
| 402 | From 70% | 0.2-10 | <10 | medium | from 10 | <15 | 5-10 |
| | | | | | (low) | | |
| 403 | From 70% | 0.2-10 | <10 | medium | from 10 | <15 | 5-10 |
| | | | | | (low) | | |
| 404 | From 50% | 0.4-20 | <10 | high | from 50 | <15 | 5-7 |
| | | | | | (medium) | | |

Over the main camera region is provided patch (404) with sheet resistance and optical transparency varying from left to right. The common bus way (401) comprises non-transparent conductive lines made of silver nano particle ink which may be connected with the transparent conductive lines or patches coated or printed over the sensitive location as a functionally graded heatable patches for the camera module. The heatable patches (402, 403, 404) have localised properties with each has slightly different properties. The properties of glass specification are considered for optimizing the defogger lines or the heating window patches in the glass. For instance, based on the thickness, size and the composition of the glass—the properties like thermal expansion, co-efficient, tensile stress of the glass are derived. Glass crack propagation is majorly due to tensile stress as glass can withstand good compressive stress. De-lamination temperature is also estimated based on the location of heating lines or patches. Based on these parameters and other relevant parameters, allowed temperature gradient and heating rate is fixed for specific application-based heating window. De-icing time of the defogger lines or heating window with the maximum temperature of glass in camera zone will be 70 degrees or less than 70 degrees. The thermal gradient across the camera glass zone is desired to be less than 10 degrees with the outside temperature. For a constant voltage, heat produced is indirectly proportional to resistance and directly proportional to time. Depending on the heat rate, de-icing time is fixed for the heating system. Additionally, temperature sensor data from outside the vehicle may be used to derive the allowed temperature gradient and to modify the resistance of the heating wires. The busway or the bus bar (401) may be optionally both transparent and non-transparent. The transparent patches (402, 403, 404) may be of silver nano-wire. It may be provided by way of conductive ink either by printing or coating or etching and adapted to be connected with the non-transparent printed lines (401) of silver nano particle around the lens or camera region.

Examples: A range of compositions have been considered and as examples are provided two instances: one with 1 mg/ml and other with 2 mg/ml. It has been observed that evidential difference in performance has been brought in by the varied compositions. This is essential and a required performance indicator for the variation required with the functionally graded of the proposed compositions according to one or more embodiments of the present invention. Table shows the observed device resistances at 1 mg/ml and 2 mg/ml compositions.

TABLE 2

| | |
|---|---|
| 1 mg/ml | 2 mg/ml |

| Printing | Device | Printing | Device | |
|---|---|---|---|---|
| Pass | resistance | Pass | resistance | Transmittance |
| (Layers) | (Ω) | (Layers) | (Ω) | at 550 nm (%) |
| 1 | — | 1 | 73.6 | 85.2 |
| 2 | 117 | 2 | 23.0 | 85.0 |
| 4 | 40 | 4 | 11.5 | 81.5 |
| 6 | 18 | 6 | 9.5 | 76.6 |

Reference is made to FIG. 5a that shows the transmittance graph for a 2 mg/ml composition. The designs and the desired specific composition may be shown as per the requirement of aesthetics and use cases. Similarly, a suitable solvent (such as Ethelen Glycol, Water, IPA solvents and in combinations thereof) may be chosen to disperse the silver nanowires. Based on ink composition a suitable concentration may be fine-tuned to obtain the desired wire length for heating.

Experiments: Thermal tests were conducted to whether the heatable patch provides an improved uniform heating on a specific region of the glazing over which the heating window is disposed. It has been observed that the uniformity in heating is enhanced when using the patch as per the present invention. Reference is made to FIG. 5b that depicts the measurements of temperature reading at two different areas of the patch providing practically uniform heating (a small deviation observed).

It has been practically observed that the patch of the heating window as per the present invention is configured to defog the region at the same time comply with the desired transparency, haze or distortion level, the optimal heating rate, the threshold temperature, the time to heat and the temperature gradient of the window and the glazing. The printed prototype of silver nano wire ink has shown increased transparency and haze (optical tests conducted with 2 pass and 4 pass).

Some of the non-limiting advantages of the present invention are:
In the present solution is provided a heating window for functionally graded transparency of the heating lines with required specification that is also location specific in nature. The functionally graded material provides desired transparency, de-icing time, temperature gradient around the glass and the circuit.
The material composition of the patch is so chosen that the heating system is configured to defog over an imaging system like a camera region on the windshield in an optimal time.
In the present invention, non-transparent bus bars are combined with transparent patches and hence both cost-effectiveness and heating functionality are achieved.
In the present invention, the heating window comprises specification which may be preferably printed as functionally graded non-transparent to transparent heating lines without affecting the performance required for the heating system and at the same time have transparent patch for uniform heating.
The solution may be used for driver assistance display in the glazing with desired luminosity, improvised experience of laminated display solution for a seamless embedding result.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

The description in combination with the figures is provided to assist in understanding the teachings disclosed herein, is provided to assist in describing the teachings, and should not be interpreted as a limitation on the scope or applicability of the teachings. However, other teachings can certainly be used in this application.

As used herein, the terms “comprises”, “comprising”, “includes”, “including”, “has”, “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

List of reference numerals appearing in the accompanying drawings and the corresponding features:
100, 200: glazing
110, 300, 400: heating window
111: heatable patches
113: metal nano constituents
114: power supply unit/busway
115: camera region
201, 205: glass
202, 204: interlayer
203: polymer base
207a, 207b: non-transparent conductive units
206a: transparent conductive units
301: silver nano particles
302: camera region
303: silver nanowire
401: Common bus bar
402: patch over a first camera lens, L1
403: patch over a second camera lens, L2
404: patch over a third camera lens, L3

1. A heating window on an automotive glazing comprising:
one or more heatable patches composed of functionally graded material containing metal nano constituents dispersed in a solvent;
a power supply unit configured to power said one or more heatable patches;
wherein the automotive glazing comprises a laminated unit of at least two panes of glass or polymer sandwiched with an interlayer therebetween; and
the one or more heatable patches are having optimal optical and thermal performance to provide improved uniform heating on a specific region of the glazing over which said heating window is disposed.

2. The heating window as claimed in claim 1, wherein said specific region of the glazing is over an arrangement of an imaging system.

3. The heating window as claimed in claim 1, wherein the patch is configured to exhibit required thermal gradient and transparency gradient.

4. The heating window as claimed claim 1, wherein a material composition of the patch is selected based on one or more of the parameters: manufacturing parameters, transparency, the thermal gradient and other thermal parameters of the window and the glazing.

5. The heating window as claimed in claim 1, wherein a composition of the functionally graded material is adapted to provide location specific optical and thermal functionalities, wherein said material exhibits same or different functionalities at different location of the window.

6. The heating window as claimed in claim 2, wherein a material composition of the patch is such that said window is optimized for required optical vision requirements of the imaging system.

7. The heating window as claimed in claim 1, wherein the solvent is an adhesive solvent whereby the patch comprises multiple silver nanowires and silver nanoparticles dispersed in it.

8. The heating window as claimed in claim 7, wherein the silver nanowires are dispersed sparsely to obtain a substantial transparency of 80-95%.

9. The heating window as claimed in claim 1, wherein the patch includes a scratch resistant, a temperature resistant, and a corrosion resistant encapsulant.

10. The heating window as claimed in claim 9, wherein the encapsulant is a metal oxide with transparency corresponding to the transparency of the patch.

11. An automotive glazing comprising the heating window as claimed in claim 1, wherein the automotive glazing is a windshield, sidelite, backlite, or quaterlite.

12. A heating system comprising one or more heating windows as claimed in claim 1, wherein the heating system is configured to heat a region over an imaging system from a first temperature to a second temperature in an optimal time.

13. The heating system as claimed in claim 12, wherein the patch of the heating window is configured to defog the region at the same time complying with the desired transparency, haze or distortion level, the optimal heating rate, the threshold temperature, the time to heat and the temperature gradient of the window and the glazing.
